(19) United States
(12) Patent Application Publication
(10) Pub. No.: US 2007/0225055 A1
(43) Pub. Date: Sep. 27, 2007

(54) PLAYING CARD IDENTIFICATION SYSTEM & METHOD

(76) Inventor: Neal Weisman, Huntington Beach, CA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/689,479

(22) Filed: Mar. 21, 2007

Related U.S. Application Data
(60) Provisional application No. 60/783,822, filed on Mar. 21, 2006.

(51) Int. Cl. G06F 19/00; A63F 9/24; A63F 9/00; A63F 1/14

(52) U.S. Cl. 463/11; 463/25; 273/148 R; 273/149 P

(57) ABSTRACT

An interactive playing card for use in a card game. The interactive playing card has a front face and a back face. The front face has a suit card value and a face card value. A readable data component attached in some way to the playing card maintains a suit card elements value and is configured to send the information in the readable data component to a display. The display will show the suit card element value and the face card element value to a viewer.

### RELATED APPLICATIONS

This application claims priority benefit of U.S. Ser. No. 60/783,822, filed Mar. 21, 2006.

### BACKGROUND

U.S. 2006/0287068 discloses a problem gambling detection in tabletop games, where a gaming establishment may determine the existence of problem gamblers within its halls by monitoring player behavior with one or more sensors from an array of sensors. In the detailed description of the invention section, on page 3 at paragraph [0048], “another possible sensor that may be used by certain embodiments of the present invention is in the chips orjettons used by the gaming establishment. Specifically, as illustrated, a chip may include a radio frequency identification tag.” Further down in the same paragraph, “The gaining establishment may associate values which each serial number. The association may be in a lookup table or the like. Alternatively, the unique identifier may be encoded to include value information.” Furthermore on page 4 in paragraph [0055], “as an alternative to reading the cards optically, playing cards may carry a conductive material on them so that they may be interrogated Tirelessly. An example of such a system is disclosed in US patent publication number 2004/0207156.”

U.S. 2004/0207156 discloses wireless monitoring of playing cards and/or wagers in gaming, where the playing cards carry conductive material which may be wirelessly interrogated via radio frequency transmission to identify a rank and/or suit for monitoring a card game. In the summary of the invention section as seen in paragraph [0010], “a playing card comprises: a face substrate having a face surface and an inner surface opposed to the face surface, the face surface of the face substrate bearing human readable rank and suit markings; and a conductive material carried by the playing card, the conductive material defining a response profile to an electromagnetic interrogation that uniquely corresponds to at least the rank marking on the face surface of the face substrate.” Furthermore as seen in the description of the related art section in paragraph [0005], “Monitoring may also allow the automation of various functions such as accounting to improve business efficiency, servicing of the tables including the delivery of extra chips when needed.” Further down in paragraph [0008], “while these RFID chips tend to be very thin, they are still large when compared to the thickness of a playing card. It is thus difficult to incorporate an RFID chip into a playing card. For example, an RFID chip laminated in a playing card may be detectable as a lump or bump by players, causing the players to reject the playing cards and take their business to the casinos. The RFID chip may throw off the balance of the playing card, again causing players to choose other casinos. The increase in thickness in the playing card may interfere with existing casino systems, such as automatic shuffle devices.”

U.S. Pat. No. 7,029,009 discloses a playing card dealing shoe with automated internal card feeding and card reading, where a distinct dealing shoe having no shuffling functionality receives shuffled, randomized or order to groups of cards. In the summary of the invention section in column 8 around line 16, “the cards are mechanically moved one at a time from the receiving area for the groups of cards to a buffer area where more than one card is temporarily stored . . . the cards are read one at a time inside of the dealing shoe, either before the buffer area or after leaving the buffer area, but before the cards are being manually removed from the card delivery area.” Further in the detailed description section in column 10 around line 66, “[a] sensor is preferably a camera. A light source may be provided to enhance the signal to the sensor.”

U.S. Pat. No. 6,361,044 discloses a card dealer for a table game. In the summary of the invention section, column 1 around line 40, “tabletop is covered by a transparent, dome-shaped cover. The tabletop has a dealer position centrally located and a player position proximal to an arcuate edge of table.” Further down around line 52, “the card carries a readable code identification thereon. A code reader of the card carrier provides a signal representation of the identification to the computer.” As seen in column 5 around line 5 of the description section, “an optical identification of each of the cards is provided by each of two barcodes printed thereon. The barcodes are oriented so that the optical identification is provided when the card is rotated 180°.” Further down in column 5 around line 42, “barcode readers are fixedly connected to the card carrier. Barcode readers pass through the base and cover.”

U.S. Pat. No. 5,941,769 discloses gaming equipment for professional use of table games with playing cards and gaming chips, in particular for the game of blackjack, as seen in the summary of the invention section, column 3 around 7, “it is an object of the invention to provide a fully automatic system of surveillance, controlling and tracking in particular for the game of blackjack.” In the description section in column 11 around line 9, “so-called smart chips can be used. These smart chips . . . have integrated electronic components functioning without a battery and acting as transponder for a radio frequency identification system (RFID system).”

U.S. Pat. No. 4,667,959 discloses an apparatus for storing and selecting cards. A card hopper is provided, which holds at least 104 cards and carousel slots for the cards. In the Disclosure of the Invention section, in column 2 around line 17, “The carousel has a base plate rotatably mounted on a central of dividers protruding from the base plate to form slots.” Further down around line 45 of page 2, “for identification of the cards, the sensor means identification markings such as bar codes, as each card is loaded into the carousel so that the apparatus can keep track of which slot holds which card.”

### BRIEF DESCRIPTION OF THE DRAWINGS

FIG. 1 is a plan view of an interactive playing card;

FIG. 2 is a plan view of an alternative embodiment of the interactive playing card;

FIG. 3 is a plan view of an alternative embodiment of the interactive playing card;

FIG. 4 is a plan view of an alternative embodiment of the interactive playing card;

FIG. 5 is a plan view of an alternative embodiment of the interactive playing card;

FIG. 6 is a plan view of an alternative embodiment of the interactive playing card;

FIG. 7 is a plan view of an alternative embodiment of the interactive playing card;

FIG. 8 is a schematic plan view of a sensory system in a game environment;

FIG. 9 is a flow chart to monitor interactive playing cards in a game;

FIG. 10 is a flow chart to integrate the interactive playing cards with affiliate software;

FIG. 11 is a flow chart to monitor the interactive playing cards for use in inventory.

### DESCRIPTION OF THE PREFERRED EMBODIMENTS

A detailed discussion of various embodiments of the interactive playing card 10 as associated with the sensors which send and receive information from the readable data component described below will now be discussed.

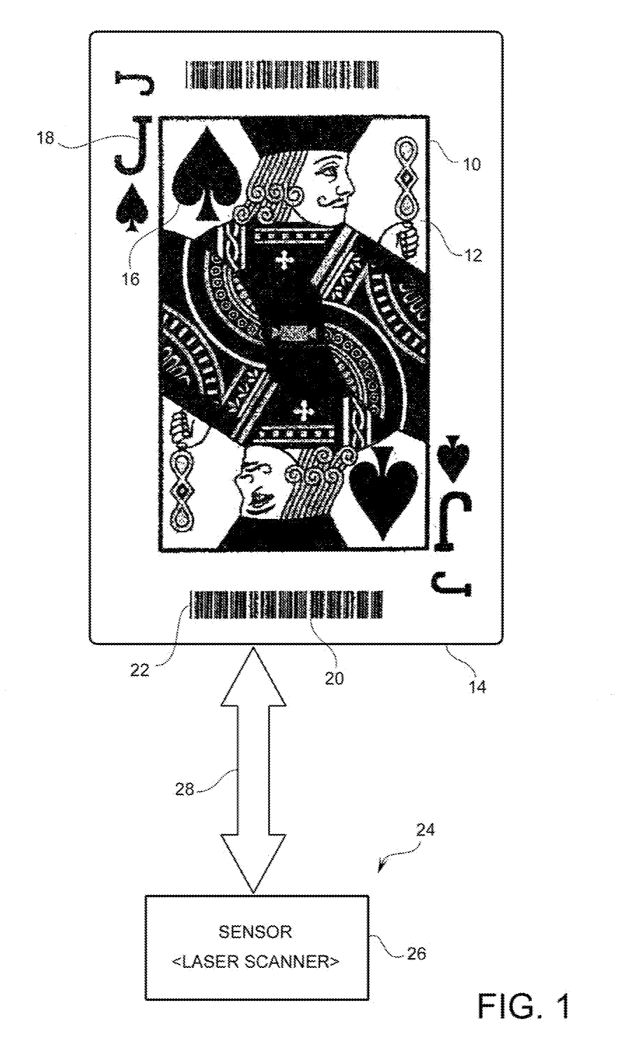

What follows is a discussion of the interactive playing card 10 as seen in FIG. 1, which has one, two, or three dimensional bar codes or an RFID chip located or interoperating with the playing card. The bar codes and/or chip can be placed on the face of the card surface, embedded within the card surface, or layered between various stratums of the playing card.

The information to be transmitted to the sensor 24, is contained within a readable data component 20. The readable data component can be the bar codes as discussed above, the RFID tag, or a combination of the above to contain or maintain data during the use life of the card.

Referring now to FIG. 1, the interactive playing card 10 is configured with the readable data component 20. The readable data component 20 in this particular embodiment is a one dimensional bar code 22. A sensor 24 can read the data component 20 by, in this case, a laser scanner 26. The readable data component 20 maintains a suit card element 16 and a face value card element 18. These card elements are correlated to the suit of the card 10 and the face value of the card 10 as seen on the front face 12 of the interactive playing card 10.

The one dimensional bar code 22 has encoded data or information as a two dimensional array of adjacent parallel rectangular bars with spaces of varying widths. As is generally known in the art, a bar code typically has identification data encoded within it; this ID data or key is used by the computer. The computer receives the laser scanner 26 information such as the infrared laser signal 28, to query the database and correlate the ID with the associated record information within the database. For example, a bar code found on a loaf of bread does not contain the product name, type of bread, or price. Instead it contains a 12 digit product number. When the bar code is scanned at the checkout, it is transmitted to the store's computer, which finds the record associated with that item number in the database. The matching item record contains information such as a description of the product, vendor name, price, and quantity on hand. One dimensional symboligies include UPC\EAN, code 39, code 128, interleaved 2 of 5 and Post NET. Code 128 and interleaved 2 of 5 are popular in the transportation industry. One dimensional bar codes are read by a sweeping of a small spot of laser lights (which may be an infrared laser) across the printed bar code symbol. A human eye will only see a thin red line emitted by the laser scanner; however the scanner light source is absorbed by the dark bars and reflected by the light spaces. This light signal 28 is then read by the sensor 24 and converted into an electrical analog signal. The digital filter in the scanner then converts the analog electrical signal into a digital signal, which is then interpreted by software as the item number.

A one dimensional bar code item number is analogous to a serial number. By itself, serial numbers are not particularly valuable. However, when combined with, as discussed below, an inventory database, and tracking stations, the serial number becomes valuable because the company's enterprise systems can derive information from the data collected about what the product is and where the product was last scanned.

This derived information can then be used to feed the downstream supply-chain applications that rely on the product flow information. The one dimensional bar code represents unique identifiers like a serial number, but it can also represent a class of items such as a part number. Identifying unique items, classes of items, or both is a conceived embodiment of the one dimensional bar codes as used in this particular embodiment. The one dimensional technologies are tethered to the enterprise system which they read into. As the number of partners using the ID increases, the number of disparate enterprise systems increases and thus the information exchange costs proportionally increase.

With the use of the one dimensional bar code technology, granular data is developed and/or generated with regard to the approximate locations of the product within the distribution chain. The one dimensional bar code 22 located on the interactive playing card front face 12, enables the producers of the interactive playing card 10 to integrate and track the card as well as card decks while using mature supporting technologies i.e. the bar code scanning technology. While discussion of the barcode 22 has been on the front face of the playing card, the bar code can be placed on the back face 14, integrated into the graphics of the card, or added on to the edge of the interactive playing card 10.

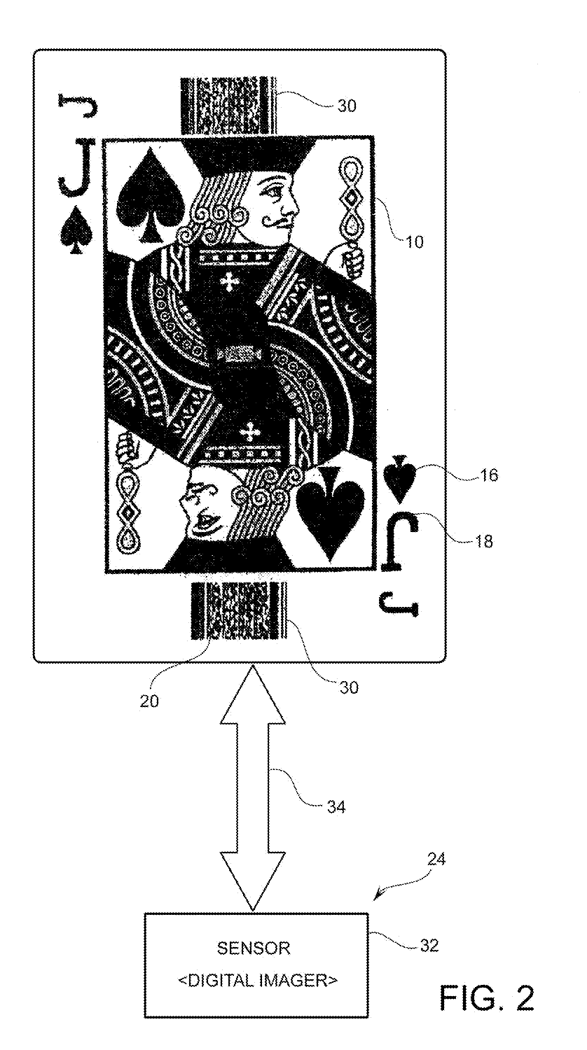

Referring to FIG. 2, the interactive playing card 10 utilizes a readable data component 20 which in this case has a two dimensional bar code 30. The two dimensional bar code also maintains the existing face value card element 18 and the suit card element 16. In addition to the previously mentioned data element, additional data components also include a client element where the client may be a casino, or a particular server location with a discreet domain. Also, a printer element which records the particular printer used to generate the data component, a card deck element which can be a serial number representing the unique actual card deck the playing card belongs to, an assigned table element, which may be correlated to the table using the pack or the deck when that particular deck is opened upon first use or subsequent uses, an assigned card game element which is correlated to the games being played at the particular table when the pack is initialized for use. A number of deals per deck element sets the number of times that the deck can be used before the deck is retired. Also, a date the deck is retired element can be correlated to the card deck element serial number for tracking within the system.

A card deck in inventory element correlates the card deck to the other card decks within the inventory.

Also, a date of destruction element can be correlated to the serial number element when the card deck is taken out of inventory and destroyed. Further, a date of sale of used deck element can be assigned and correlated to the serial number element when the deck is sold and taken out of use by the client.

The above information can be encoded or correlated to the two dimensional bar code 30 because of the two dimensional matrix symbology enabled by the horizontal and vertical axial components of the 2D matrix. Each two dimensional matrix code 30 is created as a matrix of square elements, each element being either white or black which enables the printer to generate and encode data as binary code. This allows for a very large amount of data to be correlated with the matrix symbol and along with extensive error detection and correction codes, the information can be coded in a very small amount of space.

The 2D matrix bar code 30 is read with a digital imager. This permits very fast data collection by capturing the entire symbol at once, because the sensor can recognize the two dimensional bar codes pattern of cells contained within the matrix. The cells can be square, hexagonal or circular in shape. This data is encoded relative to various horizontal and vertical positions as well as light and dark areas. Encoding schemes use air detection and correction techniques to improve reliability, and enable reading of partially damaged symbols. Two dimensional bar codes are generally used where between 10-20 data characters are desired for recordation of information. As discussed above, the 2D bar code 30 enables additional information beyond the one dimensional bar code as seen in FIG. 1, while still maintaining the two dimensional bar code on the surface of the playing card 12.

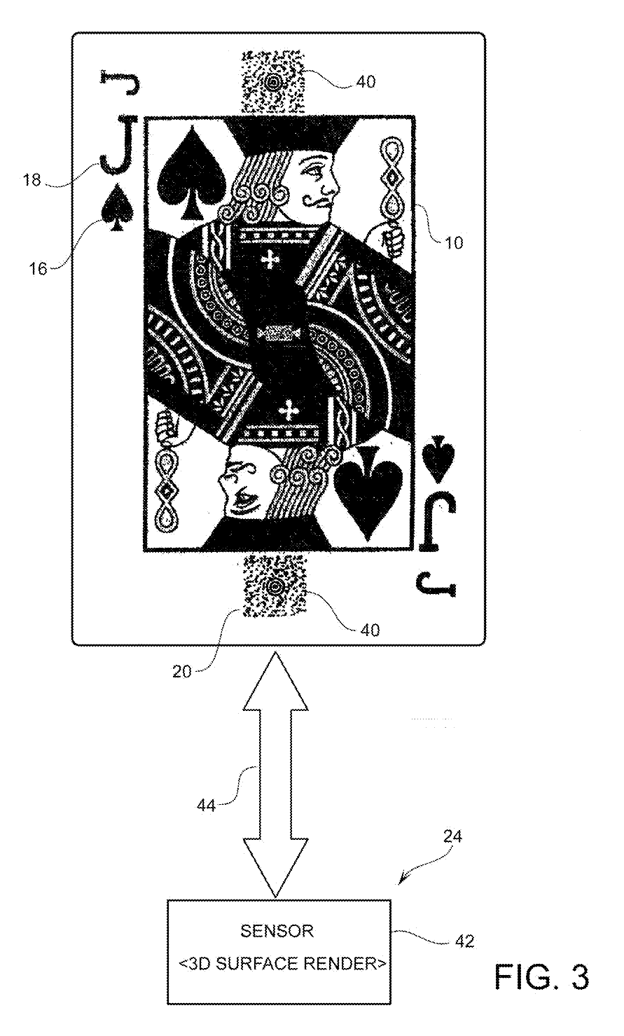

Referring to FIG. 3, a three dimensional bar code 40 is used on the interactive playing card 10 and interoperates with a sensor 24 which in this particular embodiment is a three dimensional surface reader. The three dimensional bar code 40 or in other terms called a ‘bumpy’ bar code, maintains also the suit card element 16 and the face value card element 18 which are correlated to the playing cards suit and face values. The previous additional information included in two dimensional bar codes, as seen in FIG. 2, can also be recorded within the three dimensional bar code 40. The sensor 24 as previously discussed is a three dimensional surface reader 42 and reads the bar code 40 which is directly embedded within the card 10. The signal 44 is a surface sensing signal which is read by the 3D surface reader 42.

Represented by highs and lows at surface height, similar to Braille, as well as indentations, contours, casts, penned, etches, stamped, molded or embossed three dimensional codes are embedded into the card 10. The 3D bar code 40 enables the user to collect data in environments where the black-and-white bar coding technologies are ineffective. Permanent marking of components is enabled, in this case the playing card 10, generating increased tracing capabilities. In the present technology, the 3D bar code 40 allows the playing card surface 12 to avoid having additional ink visible on the surface of the card, and the 3B bar code works the same software data transfer as the one dimensional bar code 22 (FIG. 1).

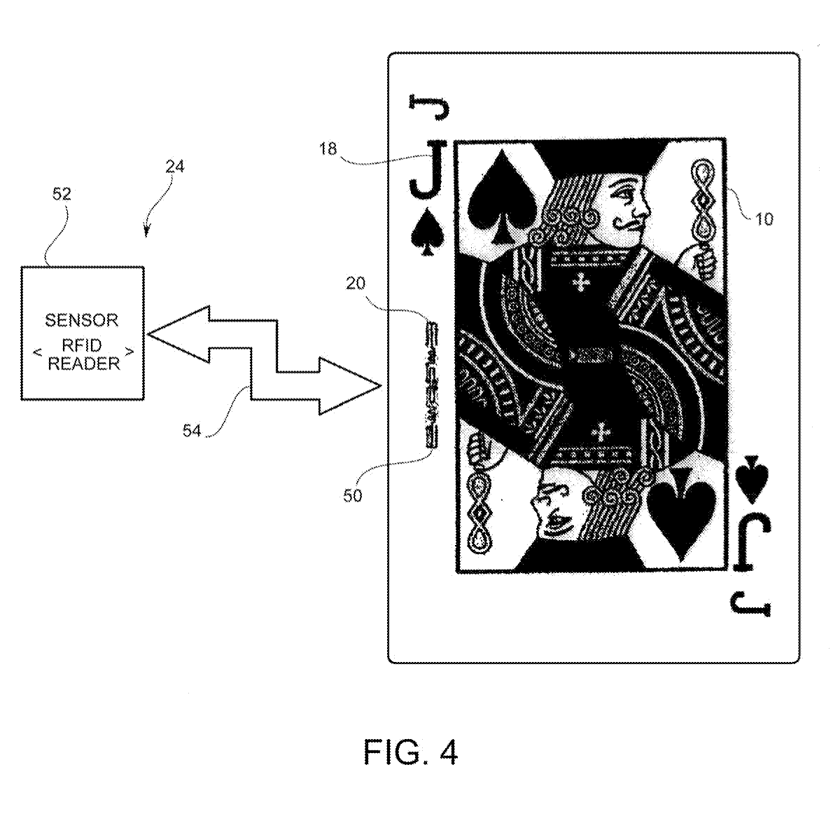

Referring to FIG. 4, a radio frequency ID tag 50 is attached to the interactive playing card 10. The readable data component 20 or in other words the radio frequency ID tag 50, maintains the suit card element 16 and face value card element 18 of the playing card suit and face value. Due to the large amount of data which can be maintained by RFID tag 50, additional information can be maintained within the circuit. The small radio frequency ID chip 50 is read by a sensor 24 which in this case is an RFID reader or scanner 52. The scanner interprets the card suit element 16 and the face value element 18 via the software which interoperates with the sensor 24. Radio frequency ID is a capture technology that uses small data carrying tokens or tags, and fixed or mobile scanners or in other words the readers.

The tags are attached to or embedded into objects to be identified and/or scanned. The RFID tags can be active or passive. In alternative embodiments, the RFID tag 50 may be an active tag, a passive tag, or in a passive sense, a Nano tag which is an RFID chip built at the micron level.

The active tag includes a battery of some sort, while the passive tag obtains energy from the radio frequency signal 54 sent from the interrogation unit 52 or the reader 52. The passive tag maintains the identification information or readable data components for the life of the tag. The active tag has a greater transmission range because of the power source maintained in operation with the active tag 50.

The sensor 24 or in this case the RFID reader 52 is installed throughout for example, the casino such as within the playing table, above or below the playing table etc. Also, the reader 52 may be portable. The data within the RFID tag 50 is transferred between various distributed readers 52 within a hosting environment via local area network or wireless area networks as discussed below.

The signal 54 is a low-power radio frequency signal. In one particular embodiment, the RFID tags are embedded with custom integrated circuits to maintain the data. In general, using the RFID tags on items such as the playing cards 10 enable the items to be tracked in real time and the items do not need to be handled by humans, i.e. the RFID tags can be polled by sending out iinterrogation signals and receiving the correlating response signal. This minimizes the time involved in the identification process of locating the cards 10 and enables high integrity of the data.

In this current embodiment, still referring to FIG. 4 the RFID tag 50 is embedded into the interactive playing card 10 during the production phase of the card. The RFID tag enables the value of the card, suit of the card, and other data points to be transmitted through the RFID sensor 52 into the operating software. In addition, RFID chips can be attached to the interactive playing cards 10 after manufacturing of both the playing cards and the RFID tags 50 during separate processes where bar code technologies would be less effective. Permanent marking of the playing card 10, generates increased tracing capabilities.

The sensors 24 as discussed more fully below are enabled to read the RFID tags 50 and can be mounted on the playing surface of the gaming table, underneath the gaming table, or over the gaming table. With the use of RFID, deep visibility of real-time data is enabled for polling of the interactive playing cards 10. The RFID tags 50 and the packaging of the decks, allow for detailed data to track the items through the casino supply chain.

In this particular embodiment, the RFID tag 50 enables additional integration with inventory control, accounting software, and data aggregation, collection, and/or dissemination of information to interested third parties. Using the RFID tag 50, real-time polling enables the existing database to keep track of the existing inventory of cards, and avoid the use of inventory cycle counts.

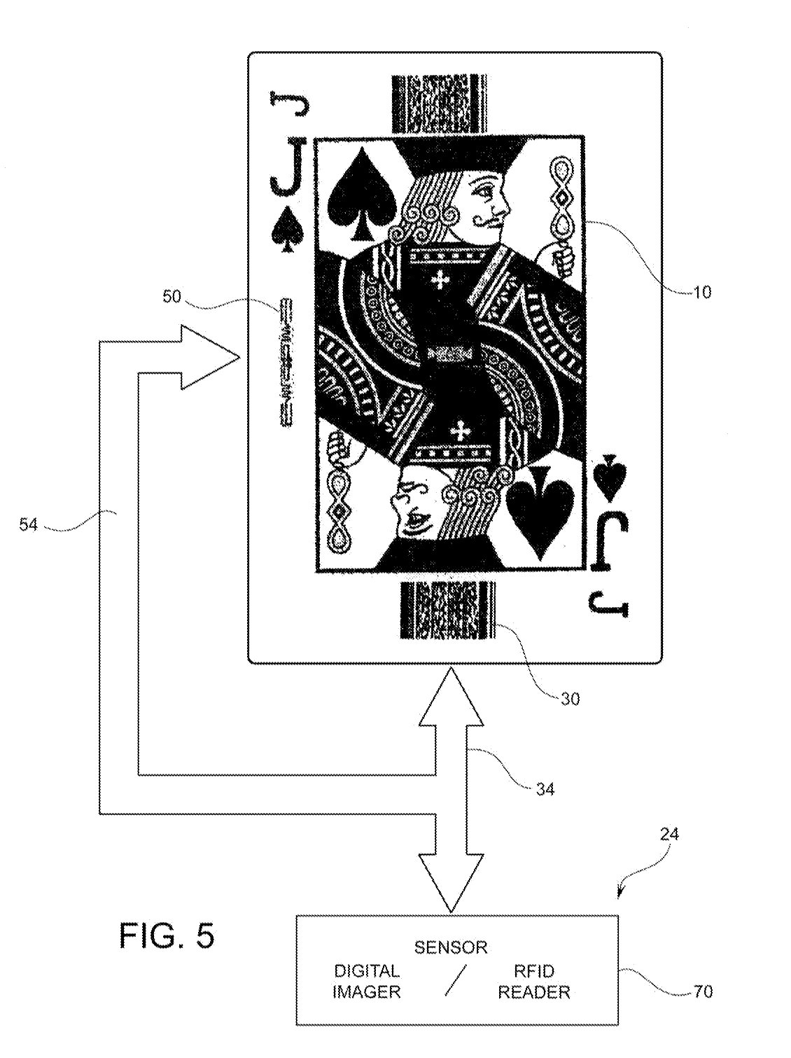

Referring to FIGS. 5-7: the readable data components can be applied to the interactive playing card 10 independently or combined to realize various combinations and sub combinations of data aggregation and scanning depending on the existing capture system, i.e. the bar code scanners or the RFID readers. For example, referring to FIG. 5, a composite sensor 24 incorporates the use of a laser scanner and an RFID reader 60, and receives two separate signals, the RFID signal 54 and the infrared laser signal 28. On the interactive playing card 10 are both the one dimensional bar code 22 and an RFID tag 50 which can be either passive or active depending on the desired metrics.

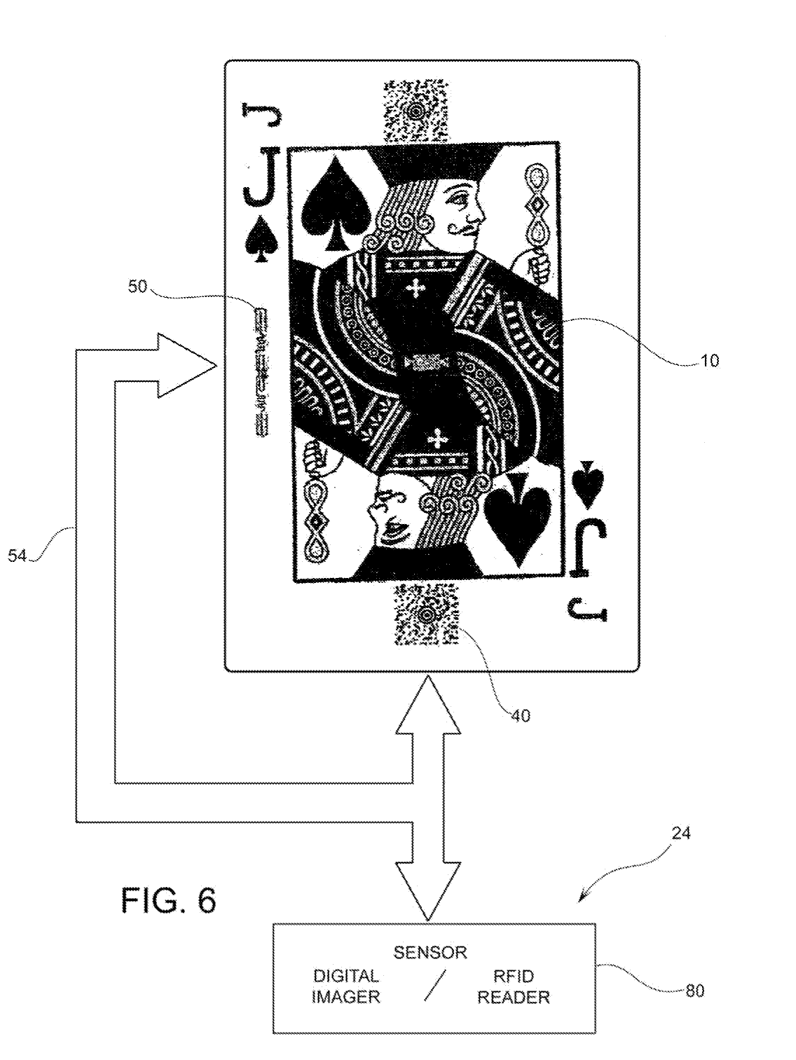

An alternative embodiment utilizes a sensor 24 with a digital imager and RFID reader composite sensor 70 as seen in FIG. 6. Here the two dimensional bar code 30 and the RFID tag 50 are interoperating with the interactive playing card 10. Again the various signals such as the RFID signal 54 and the image signal 34 are read by the composite sensor 70 to aggregate and track the various information in the respective readable data components.

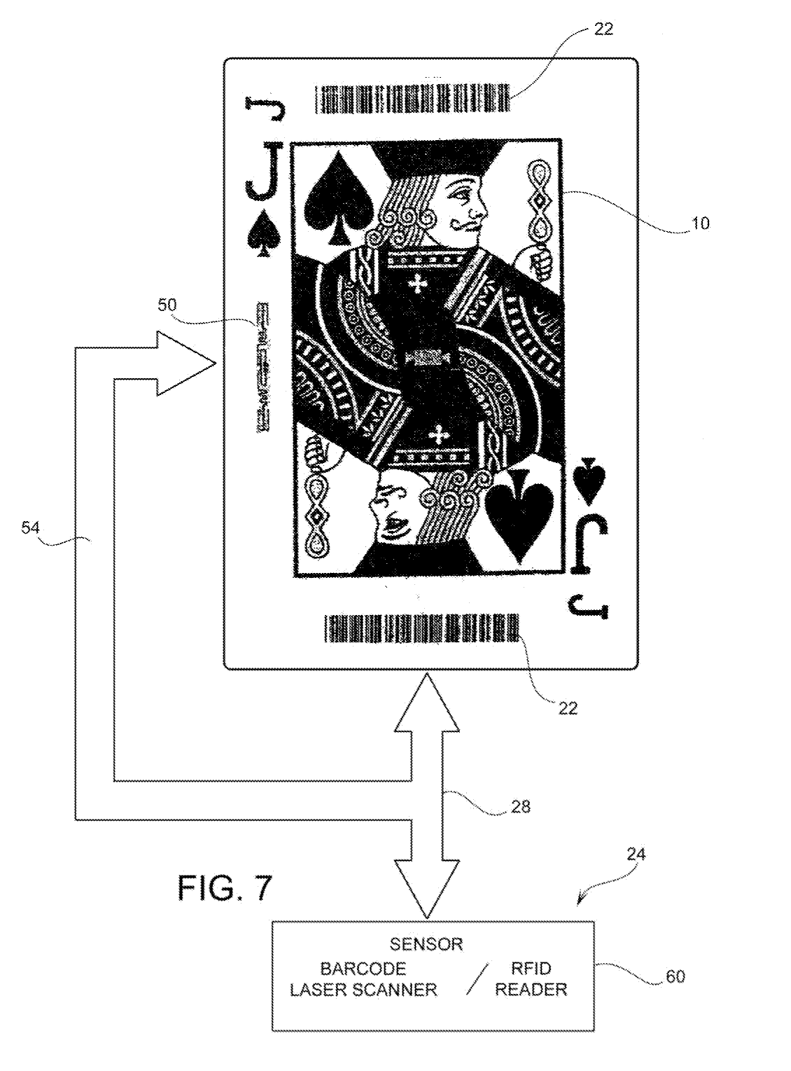

Lastly, referring to FIG. 7, a three dimensional surface reader in combination with an RFID reader composite sensor 80 receives the surface sensing signal 44 and the RFID signal 54 to read both the three dimensional bar code 40 and the RFID tag 50 maintained on the interactive playing card 10.

As will be discussed below, the interactive playing cards 10 operate in gaming environments, either live or online, as well as a combination of the two where the use of real playing cards is desired. The interactive cards 10 are handled in the traditional manner and are required to be dealt by a live dealer or person, and are required to be shuffled etc. The sensor or sensors, maintained within the gaming environments translates the readable data component information maintained on the card to software maintained within the microprocessor environment which enables the gaming software to display the information maintained within the readable data component 20 such as the face value element 18 and the suit card element 16 on either a screen at a client computer or on a monitor of some sort for spectators or guests to view.

The one dimensional, two dimensional, three dimensional, and RFID tags utilize the sensor 24 mounted on the playing surface of the gaming table. The interactive cards 10 are passed over the sensor 24 and an indication signal which is either an audible beep, click, or indicator light, is activated for the dealer to ensure accuracy of the reading of the card.

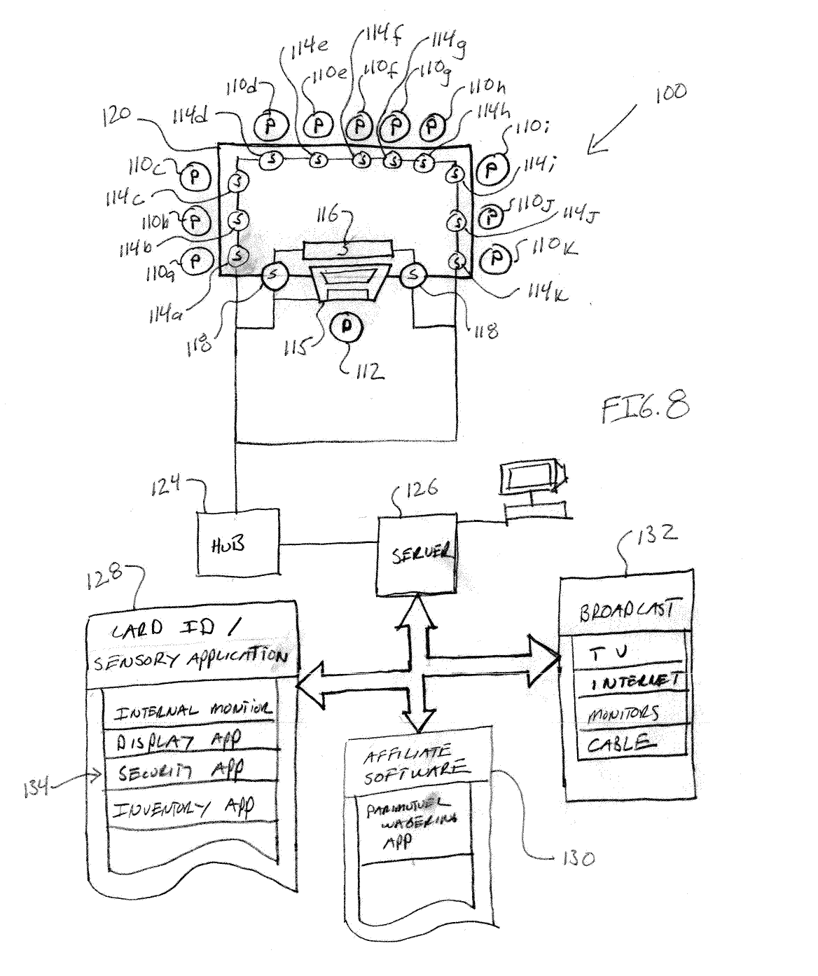

Referring to FIG. 8, a sensory system 100 is implemented to track the use of the interactive playing card 10 as previously discussed during in one embodiment a playing card game within a casino. In this particular embodiment, a group of players 110A-110K are situated about a game table 120. Correlated or placed in front of the individual players are playing card sensors 114A-114K. These sensors which as previously discussed above can be bar code sensors, or RFID sensors, which can be built into the game table, placed below the game table, placed above the game table, or situated around the edge of the game table. Also an additional embodiment would be to have the sensors as movable mats which are connected via WIFI or wireless local area network to the sensory relay hub 124. In addition to the players, a dealer 112 (who can also be a player 110), is situated at the game table 120. The dealer utilizes a sensor which is a register sensor 116 or a dealer sensor 116. The dealer sensor 116 is used by the dealer to register and/or scan new or old interactive playing card decks when used during game play.

During the course of the game, players may discard or fold certain interactive playing cards, and the dealer will pass these cards over a fold sensor 118 which in this particular embodiment is placed on either side to the left or right of the dealer position 112.

The dealer sensor 116, the player sensors 114A-114K and the fold sensors 118 are all connected, either wirelessly or via wire such as coaxial cable or the like to the server 126 through the use of a sensor relay hub 124. The dealer 112 will run a client computer 115 to initialize various game applications which will correlate with the interactive playing cards for example, the dealer may bring up a poker application on the client's computer 115 which is initialized from the server 126. The interactive playing cards 10 from the interactive playing card deck which is initialized by the dealer sensor 116, will interpret the suit card element 16 and the face value card element 18 maintained within the readable data component 20 of the interactive playing card 10 (FIG. 1), scanned by the various sensors, and correlate this information with the display software or application run by the card identification or card sensory application 128.

As the game progresses, the readable data component 20 information will be displayed in real time on various monitors and broadcast information or components 132. Furthermore, affiliate software 130 such as a parimutuel wagering application on large entrant groups, herein incorporated by reference as U.S. patent application 2006/0252520 published Nov. 9, 2006, can monitor and display the game information which is occurring at the game table 120 in real time enabling viewers to wager in pari-mutuel fashion on the entrants in the game.

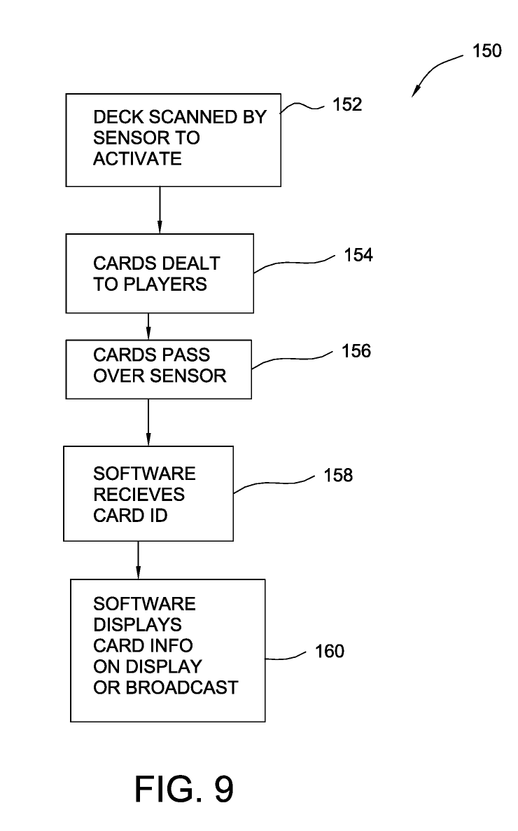

Referring now to FIG. 9, a method to monitor the interactive playing card in a game will now be discussed. During game play or tournament play, the dealer at step 152 scan the card deck with the dealer sensor 116 which registers the new deck with the card identification software or sensory application 128 activating the deck for use in the game.

No matter what game, cards are generally dealt at step 154 to the players by the dealer, the dealer either being a player or a designated house dealer. At step 156, cards are dealt, passing over the player bar code or RFID sensors which register the interactive playing cards used by the players during the game which then can be displayed on the TVs and monitors or the viewing system components 132.

In doing so, the software at step 158 recognizes the individual interactive playing card readable data components 20 as previously discussed in FIG. 1, and then at step 160 the software sends the graphic signal to the display or broadcast.

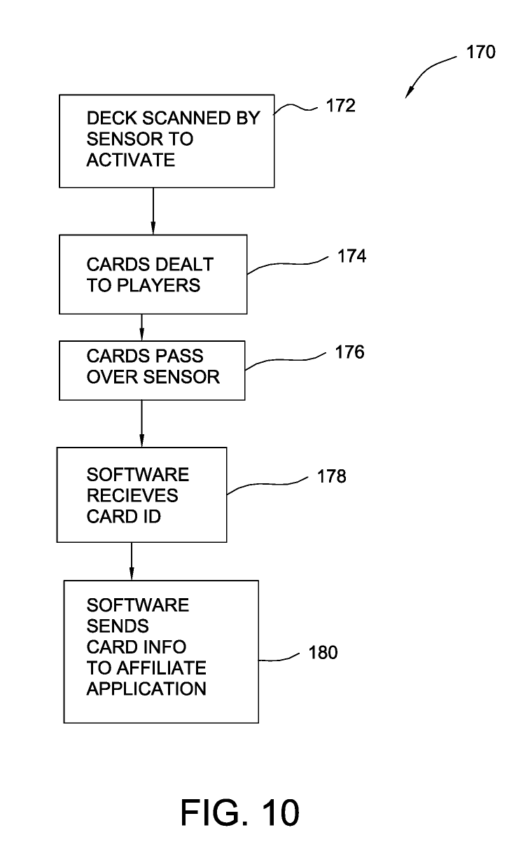

During the scanning and monitoring of the decks and individual interactive playing cards, the sensors pass the digital information to the sensory application 128 which is maintained on the server 126 as previously seen in FIG. 8. Referring now to FIG. 10, a method for integration of interactive playing cards into the software application 170 will now be provided.

The decks are scanned by the sensor at step 172 and are activated as previously discussed in FIG. 9. Then at step 174 again the cards are dealt to the players; at step 176, the cards pass over the bar code or RFID sensor, the software at step 178 recognizes the readable data component information and at step 180 sends the readable data component information to affiliate software for display and/or use in additional applications including the previously mentioned parimutuel wager on large entrant groups in a tournament.

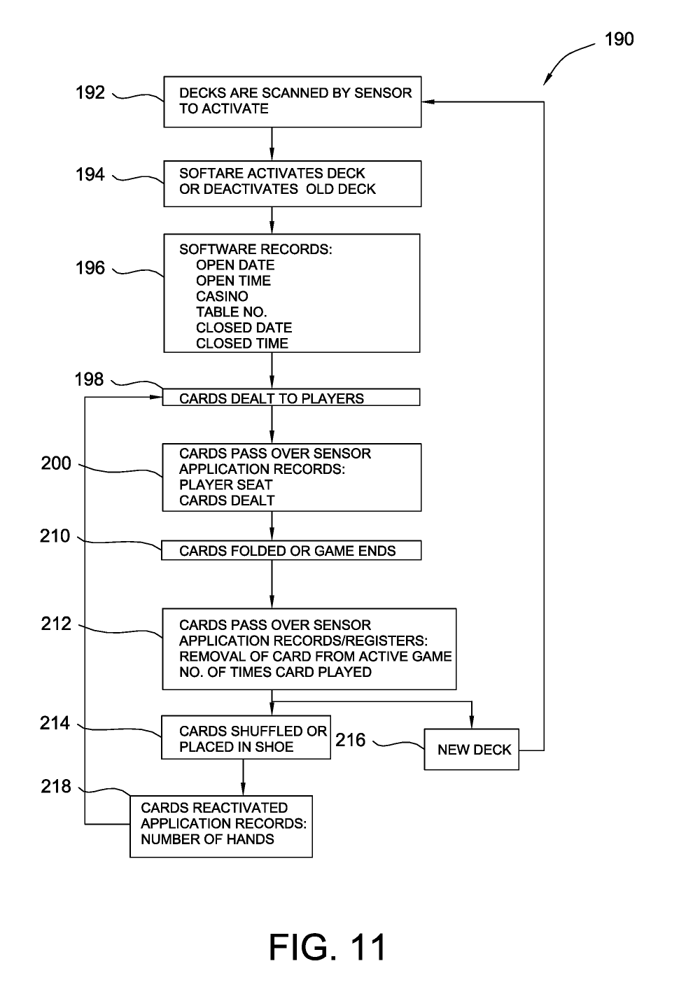

While the interactive playing card can be monitored during the play of the game, the playing card can being monitored during the life cycle of the card and tracked through the card identification software or the sensory application 128 through correlation with various databases and inventory applications 134. Referring now to FIG. 11, discussion of a method to monitor interactive playing card inventory 190 will now be provided. Even before the interactive playing card decks are delivered to the gaming location, the decks are manufactured and produced with the readable data component 20 as seen in FIG. 1, which maintains the discreet data points correlating to the application inventory software 134 which is usable through a distribution chain such as a UPC (uniform product code), or other bar code scan technologies. As the data points fill up within the inventory software 134 which correlates to the particular item or serial code as previously discussed above, the information correlated with that code increases in value within the supply chain.

When the interactive playing card deck reaches the gaming area, the interactive play card deck is scanned by the sensor and activated at step 192. The sensory application 128 as seen in FIG. 8, or the card ID software, activates at step 194 the deck or in the alternative deactivates the old deck. The sensory application 128 at step 196 records the date that the deck was opened, the time that the deck was opened, gaming location such as a casino at which the deck was opened, the table at which the deck was being used, the date at which the deck was closed out, as well as the time at which the deck was closed out. The dealer 112 will provide some of the real-time information through the use of the client computer 115 at the gaming table 120 when interfacing with the card ID software 128.

The dealer then deals the cards to the players at step 198; the cards then pass over the sensor at step 200 recording the player seat and the card dealt to the sensory application 128. After the round is complete, the cards are folded or the game ends at step 210.

Once the interactive cards are passed back to the dealer, the dealer at step 212 will register the used cards over the bar code fold sensor 118 (FIG. 8), and the sensory application 128 records the removal of the interactive playing card from the active game, as well as the number of times the interactive playing card was used for inventory purposes.

The interactive playing cards at step 214 are then shuffled back into the game play or placed into the shoe for reshuffling. The interactive playing cards are then reactivated at step 218 for redealing, and at this point the number of hands the card has been played is recorded at the sensory application 120. In the alternative, the dealer may decide to activate a new deck at step 216 which is then scanned by the sensor at step 192 as previously discussed.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. An interactive playing card comprising:
a. a front face and a back face, said front face comprising a suit card element, a face value card element, a readable data component;
b. said readable data component correlated to said suit card element and said face value card element;
c. said readable data component interoperating with a first sensor said first sensor configured to display said face value card element and suit card element to a viewer.

2. The interactive playing card according to claim 1 wherein said readable data component further comprises: a one dimensional barcode.

3. The interactive playing card according to claim 1 wherein said readable data component further comprises: a two dimensional barcode.

4. The interactive playing card according to the claim 3 wherein said readable data component further comprises: a client element, a print element, a card deck element, a card deck placed into inventory element, a card deck retired from inventory element.

5. The interactive playing card according to the claim 3 wherein said readable data component further comprises: an assigned table element, a date pack is opened element, an assigned card game element, a number of deals per deck element, a date pack is retired element, a date of destruction element, a date of sale of used deck element.

6. The interactive playing card according to claim 1 wherein said readable data component further comprises: a three dimensional barcode.

7. The interactive playing card according to the claim 6 wherein said readable data component further comprises: a client element, a print element, a card deck element, a card deck placed into inventory element, a card deck retired from inventory element.

8. The interactive playing card according to the claim 6 wherein said readable data component further comprises: an assigned table element, a date pack is opened element, an assigned card game element, a number of deals per deck element, a date pack is retired element, a date of destruction element, a date of sale of used deck element.

9. The interactive playing card according to claim 1 wherein said readable data component further comprises: a passive RFID tag.

10. The interactive playing card according to claim 9 wherein said passive RFID tag further comprises a tag size of about 50 microns to about 0.100 microns.

11. The interactive playing card according to claim 9 wherein said passive RFID tag further comprises a tag size of about a microchip.

12. The interactive playing card according to claim 1 wherein said readable data component further comprises: an active RFID tag.

13. The interactive playing card according to claim 12 wherein said active RFID tag further comprises a tag size of about 50 microns to about 0.100 microns.

14. The interactive playing card according to claim 12 wherein said active RFID tag further comprises a tag size of about a microchip.

15. The interactive playing card according to claim 1 wherein said readable data component further comprises: a nano tag.

16. The interactive playing card according to the claim 9 wherein said readable data component further comprises: a client element, a print element, a card deck element, a card deck placed into inventory element, a card deck retired from inventory element.

17. The interactive playing card according to the claim 9 wherein said readable data component further comprises: an assigned table element, a date pack is opened element, an assigned card game element, a number of deals per deck element, a date pack is retired element, a date of destruction element, a date of sale of used deck element.

18. The interactive playing card according to claim 1 when said readable data component further comprises: a first data component and a second data component.

19. The interactive playing card according to claim 18 wherein said first data component further comprises one of the following: a one-dimensional barcode, a two-dimensional barcode, a three-dimensional barcode, an RFID tag.

20. The interactive playing card according to claim 18 wherein said second data component further comprises one of the following: a one-dimensional barcode, a two-dimensional barcode, a three-dimensional barcode, an RFID tag.

21. The interactive playing card according to claim 18 wherein said first data component further comprises: an RFID tag; said second data component further comprising one of the following: a one-dimensional barcode, a two-dimensional barcode, a three-dimensional barcode, an RFID tag.

22. The interactive playing card according to claim 1 wherein said first sensor further comprises: a laser scanner configured to read a one dimensional bar code.

23. The interactive playing card according to claim 1 wherein said first sensor further comprises: a digital imager configured to read a two dimensional bar code.

24. The interactive playing card according to claim 1 wherein said first sensor further comprises: a three-dimensional surface reader configured to read a three dimensional bar code.

25. The interactive playing card according to claim 1 wherein said first sensor further comprises: a radio frequency ID reader configured to receive a radio signal from an RFID tag.

26. An interactive playing card deck comprising:
a. a plurality of interactive playing cards for use in a game;
b. each of said interactive playing cards comprising: a front face and a back face, said front face comprising a suit card element, a face value card element, a readable data component; said readable data component correlated to said suit card element and said face value card element; said readable data component interoperating with a first sensor said first sensor configured to display said face value card element and suit card element to a viewer.

27. A sensory system for a game said sensory system comprising:
a. a game table for playing a game, said game table comprising a first group of participants, said first group of participants comprising a first player, a dealer;
b. said game table further comprising a first sensor maintained at a dealer position; a second sensor maintained at a first player position;
c. said first sensor and said second sensor configured to interoperate with a first readable data component maintained on a first interactive playing card;
d. said first readable data component comprising a suit card element, a face card element; said suit card element correlated to the suit of said first interactive playing card, said face card element correlated to the face value of said first interactive playing card;
e. a sensory application interoperating with said first sensor and said second sensor to receive a first readable data component digital signal and display on a viewer said face card element and said suit card element of said first interactive playing card for entertainment of a group of spectators.

28. The sensory system according to claim 27 wherein said sensory system further comprises:
a. a first deck of interactive playing cards comprising 52 interactive playing cards including said first interactive playing card;
b. said dealer activating said first deck of interactive playing cards by registering said first deck of interactive playing cards over said first sensor.

29. The sensory system according to claim 28 wherein said first interactive playing card further comprises: said first readable data component further comprising a registration element which activates said first deck of interactive playing cards when read by said first sensor.

30. The sensory system according to claim 27 wherein said first interactive playing card further comprises a joker card.

31. The sensory system according to claim 28 wherein said sensory system further comprises:
a. a first interactive player hand comprising at least one interactive playing card from said first deck of interactive playing cards;
b. said at least one interactive playing card read by said second sensor maintained at said first player position;
c. said second sensor sending said sensory application said at least one interactive playing card an at least one readable data component digital signal for display of at least one suit card element and at least one face card element of said first interactive player hand.

32. A method of monitoring interactive playing cards in a card game said method comprising:
a. scanning an interactive playing card deck by a first sensor;
b. activating said interactive playing card deck with a sensory application;
c. dealing a first group of interactive playing cards from said interactive playing card deck to a first group of players;
d. registering said first group of interactive playing cards over a second sensor;
e. sending from said second sensor to said sensory application a suit value and a face card value from said first group of interactive playing cards as maintained by said first group of players;
f. displaying said suit value and said face card value of said interactive playing cards as maintained by said first group of players on a display.

33. A system to monitor interactive playing cards in a card game said system comprising:
a. means for scanning an interactive playing card deck by a first sensor;
b. means for activating said interactive playing card deck with a sensory application;
c. means for dealing a first group of interactive playing cards from said interactive playing card deck to a first group of players;
d. means for registering said first group of interactive playing cards over a second sensor;
e. means for sending from said second sensor to said sensory application a suit value and a face card value from said first group of interactive playing cards as maintained by said first group of players;
f. means for displaying said suit value and said face card value of said interactive playing cards as maintained by said first group of players on a display.
